(19) United States
(12) Patent Application Publication
(10) Pub. No.: US 2025/0323906 A1
(43) Pub. Date: Oct. 16, 2025

(54) SUBSTRATE INSTANCE CERTIFICATES

(71) Applicant: Oracle International Corporation, Redwood Shores, CA (US)

(72) Inventors: Kanishk Panwar, Seattle, WA (US); Girish Nagaraja, Seattle, WA (US); Neal Tucker, Seattle, WA (US)

(73) Assignee: Oracle International Corporation, Redwood Shores, CA (US)

(21) Appl. No.: 18/633,064

(22) Filed: Apr. 11, 2024

(51) Int. Cl. H04L 9/40

(52) U.S. Cl. CPC H04L 63/0823; H04L 63/166

(57) ABSTRACT

A method for issuing one or more certificates to a substrate instance of a cloud environment is disclosed. The method includes performing a first fetch to obtain one or more of: (i) an identifier of a compartment that includes the substrate instance, or (ii) an identifier of the substrate instance. The method further includes performing a second fetch to obtain an identifier of a tenancy that includes the substrate instance, based at least in part on one or more of: (i) the identifier of the compartment identified from the first fetch, or (ii) the identifier of the substrate instance identified from the first fetch. The method further includes issuing a principal certificate to the substrate instance, the principal certificate including the identifier of the tenancy that includes the substrate instance.

### BACKGROUND

A cloud provider provides on-demand, scalable computing resources (a cloud environment) to its cloud customers. The cloud environment includes a set of cloud resources that are allocated to the cloud customers. Access to a cloud resource is denied by default; access to a cloud resource is allowed only if a relevant permission has been granted via an access policy. An access policy specifies which entities are allowed to perform which actions on which cloud resources in which compartment.

Also, a Public Key Infrastructure (PKI) maintains a Certificate Authority (CA) for every cloud region of the cloud environment, where a cloud region comprises a group of cloud resources within a certain geographical region. Conventionally, CAs issue digital certificates. For example, upon successful verification of an identity of requester, one or more digital certificates can be issued to the requester. One such digital certificate is a principal certificate that represents a “principal,” or identity, endowed to the requester. Each digital certificate specifies a public key corresponding to a key pair and an identifier of an entity (e.g., user, instance, resource). A digital certificate thereby certifies that the named entity is the owner of the key pair. The digital certificate issued to an entity can be used by the entity to authenticate itself to one or more services and cloud resources of the cloud environment.

### BRIEF SUMMARY

A method for issuing one or more certificates to a substrate instance of a cloud environment is disclosed. In an example, the method includes performing a first fetch to obtain one or more of: (i) an identifier of a compartment that includes the substrate instance, or (ii) an identifier of the substrate instance. In an example, the method further includes performing a second fetch to obtain an identifier of a tenancy that includes the substrate instance, based at least in part on one or more of: (i) the identifier of the compartment identified from the first fetch, or (ii) the identifier of the substrate instance identified from the first fetch; and issuing a principal certificate to the substrate instance, the principal certificate including the identifier of the tenancy that includes the substrate instance.

In an example, the first fetch is performed by a certificate service from a substrate control plane for the cloud environment, and the second fetch is performed by the certificate service from an identity service for the cloud environment. In an example, the substrate control plane is configured to provision compute capacity in the substrate instance, and the identity service is configured to issue and/or maintain identities of a plurality of cloud resources within the cloud environment.

In an example, the substrate instance uses the principal certificate for code signing. The principal certificate may not be recognized by an authentication authority for mutual transport layer security (mTLS) authentication between the substrate instance and another entity different from the substrate instance. The principal certificate is a substrate instance principal certificate issued to the substrate instance; an overlay instance principal certificate is issued to an overlay instance that runs on the substrate instance; and in an example, the overlay instance principal certificate is recognized by the authentication authority for mTLS authentication between the overlay instance and another entity different from the overlay instance.

In an example, the first fetch is performed, based at least in part on an Internet Protocol (IP) address associated with the substrate instance. In an example, the method further includes receiving a first request for issuance of a device certificate to the substrate instance, wherein the first fetch is performed responsive at least to receiving the first request; and issuing the device certificate to the substrate instance, the device certificate including one or more of: (i) the identifier of the compartment identified from the first fetch, or (ii) the identifier of the substrate instance identified from the first fetch. The device certificate may lack the identifier of the tenancy that includes the substrate instance. In an example, the method further includes subsequent to issuing the device certificate, receiving a second request to identify one or more certificates to be issued to the substrate instance, the second request being associated with the device certificate; identifying the one or more certificates to be issued to the substrate instance based at least in part on the device certificate, the one or more certificates to be issued to the substrate instance including the principal certificate; and responsive at least to the second request, transmitting information identifying the one or more certificates to be issued to the substrate instance, wherein the information identifying the one or more certificates to be issued to the substrate instance is transmitted to the substrate instance. In an example, the method further includes subsequent to transmitting the information identifying the one or more certificates to be issued to the substrate instance, receiving a third request for the principal certificate, wherein the second fetch is performed responsive at least to receiving the third request. The one or more certificates to be issued to the substrate instance includes, in addition to the principal certificate, an additional certificate, and the method further includes subsequent to issuing the principal certificate, receiving a third request for the additional certificate; and issuing the additional certificate to the substrate instance, based at least in part on the principal certificate.

The principal certificate has a field specifying a time duration for which the principal certificate is valid. In an example, the time duration for which the principal certificate is valid is within a range of 1 hour and 7 days. In an example, the principal certificate is issued to a public key infrastructure (PKI) agent operating within the substrate instance.

Further disclosed is another method for issuing one or more certificates to a substrate instance of a cloud environment. In an example, the method includes performing a first fetch to obtain one or more of: (i) an identifier of a compartment that includes the substrate instance, or (ii) an identifier of the substrate instance, wherein the first fetch is performed by a certificate service from a substrate control plane; performing a second fetch to obtain an identifier of a tenancy that includes the substrate instance, wherein the second fetch is performed by the certificate service from an identity service; and issuing a principal certificate to the substrate instance, the principal certificate including the identifier of the tenancy that includes the substrate instance. In an example, the substrate control plane is configured to provision compute capacity in the substrate instance. In an example, the identity service is configured to issue and/or maintain identities of a plurality of cloud resources within the cloud environment.

In an example, the method further includes subsequent to performing the first fetch and prior to performing the second fetch, issuing a device certificate to the substrate instance, the device certificate including one or more of: (i) the identifier of the compartment identified from the first fetch, or (ii) the identifier of the substrate instance identified from the first fetch. In an example, the device certificate lacks the identifier of the tenancy that includes the substrate instance.

Also disclosed is a non-transitory computer-readable medium including instructions that when executed by one or more processors, cause the one or more processors to perform operations including: performing a first fetch to obtain one or more of: (i) an identifier of a compartment that includes a substrate instance of a cloud environment, or (ii) an identifier of the substrate instance. In an example, the first fetch is performed by a certificate service from a substrate control plane. The operations further include performing a second fetch to obtain an identifier of a tenancy that includes the substrate instance, based at least in part on one or more of: (i) the identifier of the compartment identified from the first fetch, or (ii) the identifier of the substrate instance identified from the first fetch. In an example, the second fetch is performed by the certificate service from an identity service. The operations further include issuing a principal certificate to the substrate instance, the principal certificate including the identifier of the tenancy that includes the substrate instance.

In an example, the substrate control plane is configured to provision compute capacity in the substrate instance; and the identity service is configured to issue and/or maintain identities of a plurality of cloud resources within the cloud environment.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a block diagram of a cloud environment including a certificate service and a substrate instance, wherein the certificate service is configured to issue a plurality of certificates to the substrate instance.

FIG. 2 illustrates a plurality of tenancies of a cloud environment, where a tenancy stores a plurality of compartments, wherein a compartment stores a plurality of substrate instances, and wherein a certificate service is configured to issue a plurality of certificates to each of the plurality of substrate instance of the plurality of tenancies.

FIG. 3 illustrates a table storing mapping between Internet Protocol (IP) addresses of substrate instances, identifiers of substrate instances, and/or identifiers of compartments including the substrate instances.

FIGS. 4A, 4B, and 4C respectively illustrate three example implementations of a table, wherein the table is usable to look up identifiers of tenancies.

FIG. 5 illustrates a flow diagram depicting communication between a substrate instance, a certificate service, a substrate control plane, and an identity service, e.g., for issuances of a plurality of certificates to the substrate instance.

FIG. 6 is a flow diagram depicting a method for issuances of a plurality of certificates to a substrate instance.

FIG. 7 depicts a simplified diagram of a distributed system for implementing certain aspects.

FIG. 8 is a simplified block diagram of one or more components of a system environment by which services provided by one or more components of an embodiment system may be offered as cloud services, in accordance with certain aspects.

FIG. 9 illustrates an example computer system that may be used to implement certain aspects.

### DETAILED DESCRIPTION

A cloud environment includes one or more cloud resources, including substrate instances and overlay instances. In the cloud environment, substrate instances represent a physical or a base layer of a cloud infrastructure. Substrate instances are also known as underlay instances, because the substrate instances form the underlaying physical infrastructure of the cloud environment. In an example, substrate instances comprise physical hardware of the cloud environment, such as physical servers, processors, storage devices, networking equipment, routers, and/or one or more other physical components. The substrate instances are the foundational layer or underlaying layer of the cloud environment. In some examples, the substrate instances are generally managed by a provider of the cloud environment, although in some other examples the substrate instances may also be rented out to a customer. The substrate instances host virtualization layers, and support execution of virtual overlay instances. Cloud customers may primarily interact with the virtual overlay instances running on the substrate instances. The overlay instances are at a higher level of abstraction, and operate on top of the substrate instances. The overlay instances are provisioned to the customers of the cloud environment. The overlay instances may include virtual machines, containers, and/or one or more other virtualized resources of the cloud environment. Although overlay instances run on top of the substrate instances, in an example, the substrate instances and the overlay instances are isolated from each other, e.g., using techniques such as virtualization and/or containerization. Cloud customers interact primarily with overlay instances, to deploy and run cloud-based applications of the customer. As described above, in an example, the substrate instances are primarily managed by the provider of the cloud environment, whereas the overlay instances are primarily managed by the cloud customer.

Typically, a certificate authority provides a certificate service, which allocates digital certificates to various cloud resources. For example, digital certificates are issued to overlay instances. For example, requisite information for obtaining digital certificates for overlay instances is readily available, and such information may be used to generate and issue digital certificates to the overlay instances. However, for substrate instances, there is no analogous service that is able to provide the requisite information to the certificate service. Accordingly, issuing digital certificates to substrate instances has been a challenge.

Techniques have been described below to support issuance of digital certificates to substrate instances. For example, a “substrate instance principal certificate” is issued to a substrate instance. One or more other digital certificates may also be issued to one or more other nodes or agents of the substrate instance, to enable such agents to avail themselves of one or more corresponding services. In an example, by granting a substrate instance principal certificate and one or more other digital certificates to a substrate instance, an agent operating therewithin can reference to a certificate in performing its operations.

In an example, to issue one or more certificates to a substrate instance, a certificate service has to fetch information from two different cloud resources, such as (i) fetch information from a substrate control plane and (ii) also fetch information from an identity service. For example, the substrate control plane maintains a first set of information about the substrate instance, and the identity service maintains a second set of information about the substrate instance, where the certificate service has to access both the first and second set of information to issue certificates to the substrate instance. Accordingly, the certificate service has to communicate with both the substrate control plane and the identity service, in order to issue certificates to the substrate instance.

A cloud environment comprises one or more cloud regions, where each cloud region comprises one or more cloud tenancies. In an example, each tenancy may be rented to a corresponding cloud customer, such that tenancies of different cloud customers are isolated from each other. In an example, overlay instances of a tenancy may run on top of substrate instances of the tenancy. Each tenancy comprises a plurality of compartments. Each compartment is a logical group of corresponding one or more cloud resources. Compartments within a tenancy enable partitioning of resources within the tenancy in two or more groups corresponding to two or more compartments of the tenancy, e.g., to define rules with finer granularity for cloud resources within the tenancy, as described below in further detail. Thus, each compartment includes a plurality of substrate instances.

In an example, the above-described substrate control plane is configured to provision compute capacity in various substrate instances. Thus, as the substrate control plane has provisioned the compute capacity in a substrate instance, the substrate control plane is aware of an IP address of the substrate instance, along with an identifier of the substrate instance and an identifier of the compartment including the substrate instance. Accordingly, the substrate control plane is aware of a mapping between an IP address of a substrate instance, a substrate instance identifier, and a corresponding a compartment identifier. Accordingly, in an example, the substrate control plane populates and updates a first table, and accesses the first table to look up a substrate instance identifier corresponding to an IP address of a substrate instance, and also a compartment identifier corresponding to the substrate instance identifier.

In an example, the above-described identity service is configured to manage authentication and/or authorization for accessing a plurality of substrate instances in the cloud environment. In an example, the identity service is aware of a mapping from an identifier of a substrate instance and/or an identifier of a corresponding compartment to an identifier of a corresponding tenancy. In an example, the identity service populates and updates a second table, and accesses the second table to look-up a tenancy identifier corresponding to a substrate instance identifier and/or a compartment identifier.

Assume a scenario where an IP address of a substrate instance is known, and it is desired to determine (i) an identifier of the substrate instance, (ii) an identifier of the compartment including the substrate instance, and (iii) an identifier of the tenancy including the compartment and the substrate instance. In an example, to determine such identifiers from the IP address of the substrate instance, both the above-described first and second tables may have to be accessed.

For example, when issuing certificates to a substrate instance, the certificate service initially receives an IP address of the substrate instance. The substrate control plane reads the first table, to determine from the IP address of the substrate instance, (i) the identifier of the substrate instance, and (ii) the identifier of the compartment including the substrate instance. Subsequently, the identity service reads the second table to determine, from the identifiers of the compartment and/or the substrate instance, the identifier of the tenancy.

Thus, prior to issuing the certificates to a substrate instance, the certification service performs a first fetch from the substrate control plane, to fetch an identifier of the substrate instance and an identifier of a compartment including the substrate instance, where the first fetch is based on an IP address of the substrate instance. Subsequently, the certification service performs a second fetch from the identity service, to fetch an identifier of a tenancy including the substrate instance, where the second fetch is based on the identifiers of the substrate instance and/or the compartment from the first fetch. Subsequently, the certification service issues a principal certificate to the substrate instance, where the principal certificate includes at least the identifiers of (i) the substrate instance, (ii) the compartment including the substrate instance, and (iii) the tenancy including the compartment. In an example, the principal certificate may also include other relevant information, such as a type of cloud resource holding the certificate (e.g., where the type is a “substrate instance”), one or more permitted usages of the certificate, a time duration for which the certificate is valid, a host name of the substrate instance, etc. Subsequently, one or more additional certificates may also be issued to one or more agents of the substrate instance, as described below in further detail.

### Cloud Environment and Issuance of Certificates

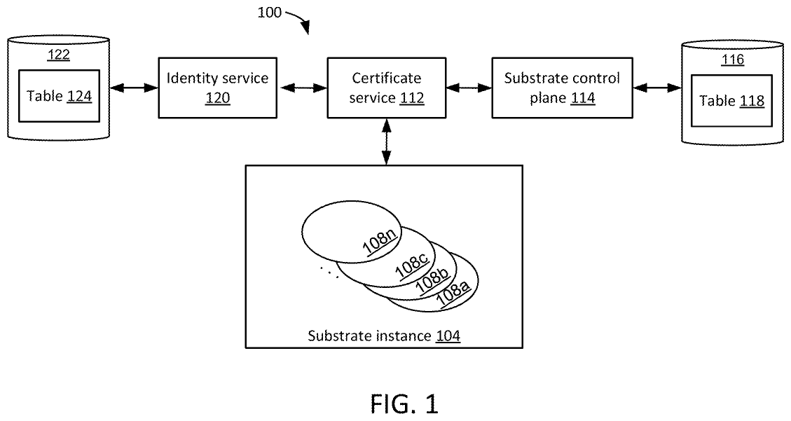

FIG. 1 illustrates a block diagram of a cloud environment 100 including a certificate service 112 and a substrate instance 104, wherein the certificate service 112 is configured to issue a plurality of certificates to the substrate instance.

As described herein above, in the cloud environment 100, a substrate instance (such as the substrate instance 104) represents a physical or a base layer of the cloud infrastructure. Substrate instances are also known as underlay instances, because the substrate instances form the underlaying physical infrastructure of the cloud environment. In an example, substrate instances comprise physical hardware of the cloud environment, such as physical servers, processors, storage devices, networking equipment, routers, and/or one or more other physical components. The substrate instances are the foundational layer or underlaying layer of the cloud environment 100. In some examples, the substrate instances are generally managed by a provider of the cloud environment, although in some other examples the substrate instances may also be rented out to a customer. The substrate instances host the virtualization layer, and support execution of virtual overlay instances. Cloud customers may primarily interact with the virtual overlay instances running on the substrate instances. The overlay instances are at a higher level of abstraction, and operate on top of the substrate instances. The overlay instances are provisioned to the customers of the cloud environment 100. The overlay instances may include virtual machines, containers, and/or one or more other virtualized resources of the cloud environment 100. Although overlay instances run on top of the substrate instances, in an example, the substrate instances and the overlay instances are isolated from each other, e.g., using techniques such as virtualization and/or containerization. Cloud customers interact primarily with overlay instances, to deploy and run cloud-based applications of the customer. As described above, the substrate instances are primarily managed by the provider of the cloud environment 100, whereas the overlay instances are primarily managed by the cloud customer. Thus, the cloud customer may not manage the substrate instances comprising the underlying physical resources of the cloud environment 100. Thus, the substrate instance 104 of FIG. 1 represents a physical resource of the cloud environment 100.

In an example, the substrate instance 104 executes a plurality of agents 108a, . . . , 108n, where “n” is a positive integer greater than one. Thus, there are at least two agents within the substrate instance 104.

Each of the agents 108a, . . . , 108n is configured to perform corresponding one or more tasks within the substrate instance 104. For example, the 108a may be a certification agent configured to communicate with a certificate service 112 for issuance of a substrate principal certificate to the substrate instance 104, as described below. In an example, one or more of the agents 108a, . . . , 108n, such as at least the agent 108a, is a PKI agent associated with receiving and/or maintaining one or more certificates for the substrate instance 104.

The 108b may be a workload protection agent (WLP) configured to protect a workload of the substrate instance 104. For example, the agent 108b may monitor one or more operations of the substrate instance 104, and/or query the substrate instance 104, e.g., to detect any anomalous or suspicious activity of or within the substrate instance 104. Results of such monitoring and/or query may be transmitted to a component external to the substrate instance 104. Thus, the agent 108b may be configured to monitor operational security aspects of the substrate instance 104, and may also be referred to as a security agent. In an example, in addition to (or instead of) monitoring the operations and/or query the substrate instance 104, the agent 108b may also communicate with the certificate service 112, to facilitate issuance of a certificate to the agent 108b. In an example, the agent 108b (or another agent) may use the certificate issued to the agent 108b, e.g., to authenticate the agent 108b (or another agent) with another service provider within the cloud environment 100, and/or to obtain one or more services from the service provider.

Similarly, one or more of the other agents 108c, . . . , 108n may perform one or more corresponding tasks, and/or communicate with the certificate service 112 to facilitate issuance of one or more corresponding certificates from the certificate service 112. Thus, in an example, one or more of the plurality of agents 108a, . . . , 108n (such as each of the plurality of agents 108a, . . . , 108n) is configured to communicate with the certificate service 112 of the cloud environment 100, to obtain corresponding plurality of certificates for the substrate instance 104.

The cloud environment 100 further includes the certificate service 112. In an example, the certificate service 112 is configured to issue certificates to the substrate instance 104 and to a plurality of other substrate instances, as described below in further detail.

The cloud environment 100 further includes a substrate control plane 114. In an example, the substrate control plane 114 is configured to provision a compute capacity in the substrate instance 104 and in a plurality of other substrate instances. Operation of the substrate control plane 114 is described below in further detail.

In an example, the substrate control plane 114 has access to a repository 116 storing at least a table 118. The table 118 is a lookup table, for example. In an example, the table 118 stores mapping between IP addresses of substrate instances, identifiers of substrate instances, and/or identifiers of compartments including the substrate instances, as described below in further detail.

The cloud environment 100 further includes an identity service 120 that is separate and different from the substrate control plane 116. In an example, the identity service 120 manages one or more of authentication or authorization for accessing a plurality of substrate instances in the cloud environment. Additionally, or alternatively, in an example, the identity service 120 issues and/or maintains identities of a plurality of cloud resources within the cloud environment, such as the substrate instance 104. The identity service 120 is described below in further detail.

In an example, the identity service 120 has access to a repository 122 storing at least a table 124. The table 124 is a lookup table, for example. In an example, the table 124 stores a mapping from identifiers of compartments and/or identifiers of substrate instances to corresponding identifiers of tenancies including the compartments and/or the substrate instances, as described below in further detail.

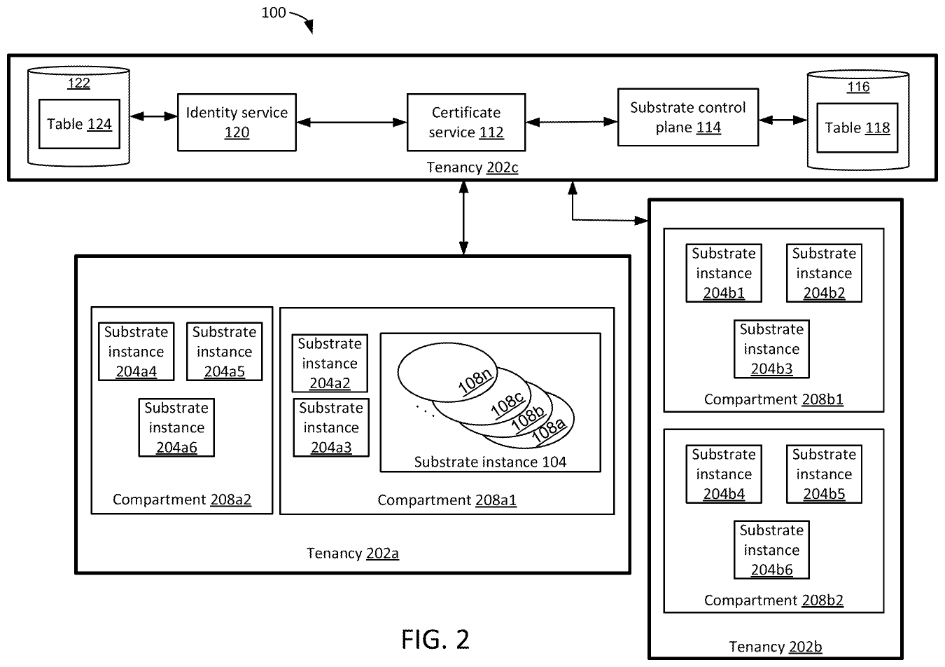

FIG. 2 illustrates a plurality of tenancies 202a, 202b of the cloud environment 100, where a tenancy 202 stores a plurality of compartments 208, wherein a compartment 208 stores a plurality of substrate instances 104, 204a2, . . . , 204b6, and wherein the certificate service 112 is configured to issue a plurality of certificates to each of the plurality of substrate instances 104, 204a2, . . . , 204b6 of the plurality of tenancies.

Note that the plurality of substrate instances 104, 204a2, . . . , 204b6 illustrated in FIG. 2 includes the substrate instance 104 of FIG. 1. At least some of the description of this disclosure is directed towards issuance of a plurality of certificates to an example substrate instance 104. However, such description also applies to issuance of a plurality of certificates to each of one or more other substrate instances, such as each of one or more of (or all of) the substrate instances 204a2, . . . , 204b6 of the cloud environment of FIG. 2.

In an example, each tenancy 202 may be rented to a corresponding cloud customer, such that tenancies of different cloud customers are isolated from each other. For example, overlay instances of the tenancy 202a may run on top of the substrate instances of the tenancy 202a, and overlay instances of the tenancy 202b may run on top of the substrate instances of the tenancy 202b.

In an example, a tenancy 202c may also be used and operated by the cloud provider, such as to provide one or more services to the cloud environment 100. In an example, each of the tenancies 202a, 202b may be referred to as a customer tenancy, as these tenancies are rented out to cloud customers. In contrast, the tenancy 202c may be referred to as a service tenancy operated by the cloud provider.

Although each of the identity service 120, the certificate service 112, the substrate control plane 114, and the repositories 116, 122 are illustrated to be included within the same tenancy 202c, such components may be spread out in two or more different tenancies as well in one example. In an example, one or more of these components may also be included in at least one of the tenancies 202a, 202b.

In an example, the certificate service 112 is configured to issue certificates to one or more cloud resources (such as the substrate instances) within a cloud region of the cloud environment 100, where a cloud region comprises a group of cloud resources within a certain geographical region. Thus, certificate service 112 may issue certificates to a plurality of (such as all) substrate instances within the corresponding cloud region of the cloud environment 100.

Although three tenancies 202a, 202b, 202c of the cloud environment 100 are illustrated in FIG. 2, the cloud environment 100 may include any appropriate number of tenancies, such as one, four, five, or a higher number of such tenancies.

The tenancy 202a comprises compartments 208a1 and 20a2, and the tenancy 202b comprises compartments 208b1 and 20a2. Each compartment is a logical group of corresponding one or more cloud resources. Compartments within a tenancy enable partitioning of resources within the tenancy in two or more groups corresponding to two or more compartments of the tenancy, e.g., to define rules with finer granularity for cloud resources within the tenancy. For example, it may be desired that first one or more cloud resource within a tenancy follow a first set of rules, and second one or more cloud resource within the tenancy follow a second set of rules. Accordingly, the first one or more cloud resource may be logically grouped in a first compartment, and the first set of rules may be defined at the compartment level for the first compartment, such that the first one or more cloud resources grouped within the first compartment follow the first set of rules. Similarly, the second one or more cloud resource may be logically grouped in a second compartment, and the second set of rules may be defined at the compartment level for the second compartment, such that the second one or more cloud resources grouped within the second compartment follow the second set of rules.

Although the tenancy 202a includes two compartments 208a1, 208a2 and the tenancy 202b includes two compartments 208b1, 208b2, each of these tenancies may include any other appropriate number of compartments, such as three, four, or a higher number of compartments.

The compartment 28a1 includes substrate instances 104, 204a2, 204a3, where the substrate instance 104 of the compartment 208a1 is also illustrated in FIG. 1. The compartment 28a2 includes substrate instances 204a4, 204a5, 204a6; the compartment 208b1 includes substrate instances 204b1, 204b2, 204b3; and compartment 28b2 includes substrate instances 204b4, 204b5, 204b6. Although each compartment in FIG. 2 is illustrated to include three substrate instances, each of these compartments may include any appropriate number of substrate instances, such as one, two, four, or a higher number of substrate instances.

As described above, the cloud environment 100 includes the repository 116 storing at least the table 118, where the table 118 stores mapping between IP addresses of substrate instances, identifiers of substrate instances, and/or identifiers of compartments including the substrate instances. For example, the table 118 stores a mapping from an IP address of a substrate instance to an identifier of the substrate instance, and also stores a mapping from an identifier of the substrate instance to an identifier of a compartment including the substrate instance. Thus, for example, if the substrate control plane 114 provides an IP address of the substrate instance 104 to the table 118, the table 118 returns an identifier of the substrate instance 104 and/or an identifier of the compartment 208a1 including the substrate instance 104.

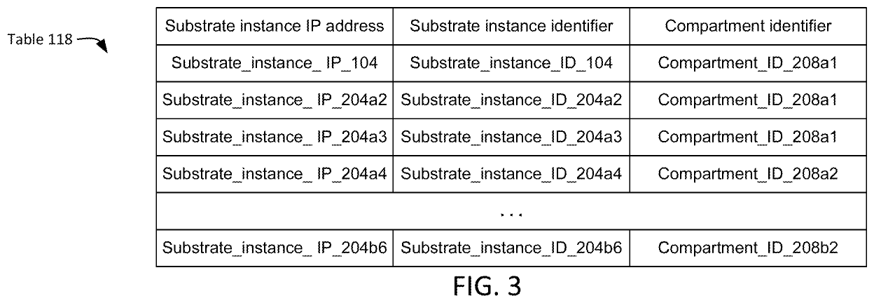

FIG. 3 illustrates the table 118 storing mapping between IP addresses of substrate instances, identifiers of substrate instances, and/or identifiers of compartments including the substrate instances. For example, the first column of the table 118 stores IP addresses of various substrate instances, the second column of the table 118 stores identifiers of various substrate instances, and the third column of the table 118 stores identifiers of various compartments including the substrate instances. For example, referring to the first row of the table 118, the IP address of the substrate instance 104 is symbolically labelled as “Substrate_instance_IP_104.” A corresponding identifier of the substrate instance 104 is mapped in the table 118, and is symbolically labelled as “Substrate_instance_ID_104.” The identifier of the corresponding compartment 208a1 including the substrate instance 104 is also mapped in the table 118, and is symbolically labelled as “Compartment_ID_208a1.” Similarly, various other IP addresses of various other substrate instances are mapped to the corresponding identifiers of the substrate instances, and to the corresponding identifiers of the compartments.

In an example and as also described above, the substrate control plane 114 is configured to provision compute capacity in various substrate instances. In an example, because the substrate control plane 114 has provisioned the compute capacity in a substrate instance, the substrate control plane 114 is aware of an IP address of the substrate instance, along with an identifier of the substrate instance and an identifier of the compartment including the substrate instance (e.g., because the substrate control plane 114 may implement compartment-level rules of the compartment to the associated substrate instances).

Accordingly, the substrate control plane 114 is aware of a mapping between an IP address of a substrate instance, a substrate instance identifier, and a corresponding a compartment identifier. Accordingly, in an example, the substrate control plane 114 populates and updates the table 118, and accesses the table 118 to look-up a substrate instance identifier corresponding to an IP address of a substrate instance, and also a compartment identifier corresponding to the substrate instance identifier.

In an example, while the substrate control plane 114 is aware of the above-described mapping between an IP address of a substrate instance, a substrate instance identifier, and a corresponding a compartment identifier, the substrate control plane 114 may not be aware of a tenancy in which a substrate instance or the compartment is included. For example, although the substrate control plane 114 is aware of the compartment 208a1 including the substrate instance 104, the substrate control plane 114 may not know a tenancy including the substrate instance 104 or the compartment 208a1. Accordingly, in an example, the table 118 may be unable to map an IP address and/or an identifier of a substrate instance (or an identifier of a compartment) to a tenancy including the substrate instance.

Referring again to FIG. 2 and as described above, the cloud environment 100 further includes the repository 122 storing at least the table 124, where the table 124 stores mapping from identifiers of substrate instances and/or the compartments to identifiers of tenancies including the substrate instances and/or the compartment. For example, if the identity service 120 transmits an identifier of the substrate instance 104 and/or an identifier of the compartment 208a1 to the table 124, the table 124 returns an identifier of the tenancy 202a including the substrate instance 104 and the compartment 208al.

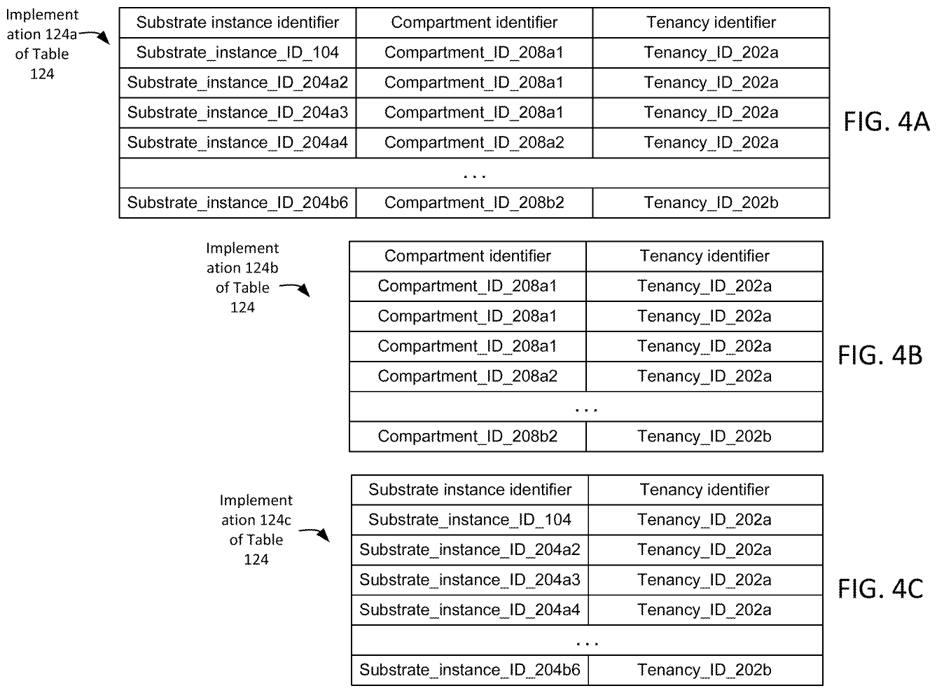

FIGS. 4A, 4B, 4C respectively illustrate three example implementations 124a, 124b, 124c of the table 124, wherein the table 124 is usable to look up identifiers of tenancies.

In the example implementation 124a of FIG. 4A, the table 124 stores mapping from identifiers of substrate instances and identifiers of compartments to corresponding identifiers of tenancies including the substrate instances and the compartments. For example, the first column of the table 124 stores identifiers of various substrate instances, the second column of the table 124 stores identifiers of various compartments, and the third column of the table 124 stores identifiers of various tenancies.

Referring to the first row of the table 124a of FIG. 4A, the identifier of the substrate instance 104 is symbolically labelled as “Substrate_instance_ID_104.” The identifier of the corresponding compartment 208a1 including the substrate instance 104 is mapped in the table 124, and is symbolically labelled as “Compartment_ID_208a1.” The identifier of the corresponding tenancy 202a including the substrate instance 104 and the compartment 208a1 is also mapped in the table 124, and is symbolically labelled as “Tenancy_ID_202a.” Similarly, various other identifiers of the substrate instances and/or the compartments are mapped to the corresponding identifiers of the tenancies.

Note that in the example implementation 124a of the table 124 in FIG. 4A, identifiers of both substrate instances and compartments are mapped to the identifiers of the tenancies. However, in another example and as illustrated in FIG. 4B, identifiers of the compartments (and not identifiers of the substrate instances) can be mapped to the identifiers of the tenancies. In yet another example and as illustrated in FIG. 4C, identifiers of the substrate instances (and not identifiers of the compartments) can be mapped to the identifiers of the tenancies.

Thus, in FIGS. 4A-4C, the various implementations of the table 124 map identifiers of the substrate instances and/or the compartments to the identifiers of the tenancies.

In an example and as also described above, the identity service 120 is configured to manage one or more of authentication or authorization for accessing a plurality of substrate instances in the cloud environment. Additionally, or alternatively, in an example, the identity service 120 issues and/or maintains identities of a plurality of cloud resources within the cloud environment. Accordingly, in an example, the identity service 120 is aware of a mapping from an identifier of a substrate instance and/or an identifier of a corresponding compartment to an identifier of a corresponding tenancy. Accordingly, in an example, the identity service 120 populates and updates the table 124, and accesses the table 124 to look-up a tenancy identifier corresponding to a substrate instance identifier and/or a compartment identifier.

In an example, while the identity service 120 is aware of the above-described mapping, the identity service 120 may be unaware of an IP address of a substrate instance (e.g., the substrate control plane 114 may instead be aware of the IP address of the substrate instance). Accordingly, the identity service 120 may not be aware of a mapping from the IP address of a substrate instance to the identifier(s) of the corresponding substrate instance, the compartment, and/or the tenancy.

As described above, in one example, the identity service 120 is aware of the mapping from an identifier of a substrate instance and/or an identifier of a corresponding compartment to an identifier of a corresponding tenancy. In another example, the identity service 120 receives such mapping information from another service, such as a compartments service. Additionally or alternatively, the certificate service 112 may request the mapping from the substrate instance identifier and/or the compartment identifier to the tenancy identifier directly from the compartments service. The compartments service allows cloud customers to setup and manage the compartments (such as compartments 208a1, . . . , 208b2). Within the compartments service, the cloud customer may create, move, rename, delete, and/or recover compartments within a tenancy of the cloud customer. Compartments are a logical boundary that groups resources; each cloud resource exists in a compartment. Compartments are a hierarchical construct; it allows customers to vertically manage resources. The root compartment may be referred to as a “tenancy.” This construct can be used for a number of purposes, including: setting access policies for cloud resources on a compartment basis (security); setting usage limits or billing policies on a compartment basis (metering/billing); setting governance or compliance rules on a compartment basis (compliance/audit); serving as a container for resources that are moved as a group, e.g., moving resources in one tenancy into a compartment of another tenancy (mergers/changes); serving as a container for resources that interact with a third-party (third-party integrations), and/or the like. In an example, the identity service 120 and/or the compartments service (not illustrated in FIG. 1A) may work together to provide the requested mapping from the substrate instance identifier and/or the compartment identifier to the tenancy identifier from the compartments service. Thus, the table 124 may be populated by the identity service 120 and/or the compartments service.

Assume a scenario where an IP address of a substrate instance is known, and it is desired to determine (i) an identifier of the substrate instance, (ii) an identifier of the compartment including the substrate instance, and (iii) an identifier of the tenancy including the compartment and the substrate instance. In an example, to determine such identifiers from the IP address of the substrate instance, both tables 118 and 124 may have to be accessed. For example, the table 118 is read to determine, from the IP address of the substrate instance, (i) the identifier of the substrate instance, and (ii) the identifier of the compartment including the substrate instance. Subsequently, the table 124 is read to determine, from the identifiers of the compartment and/or the substrate instance, the identifier of the tenancy.

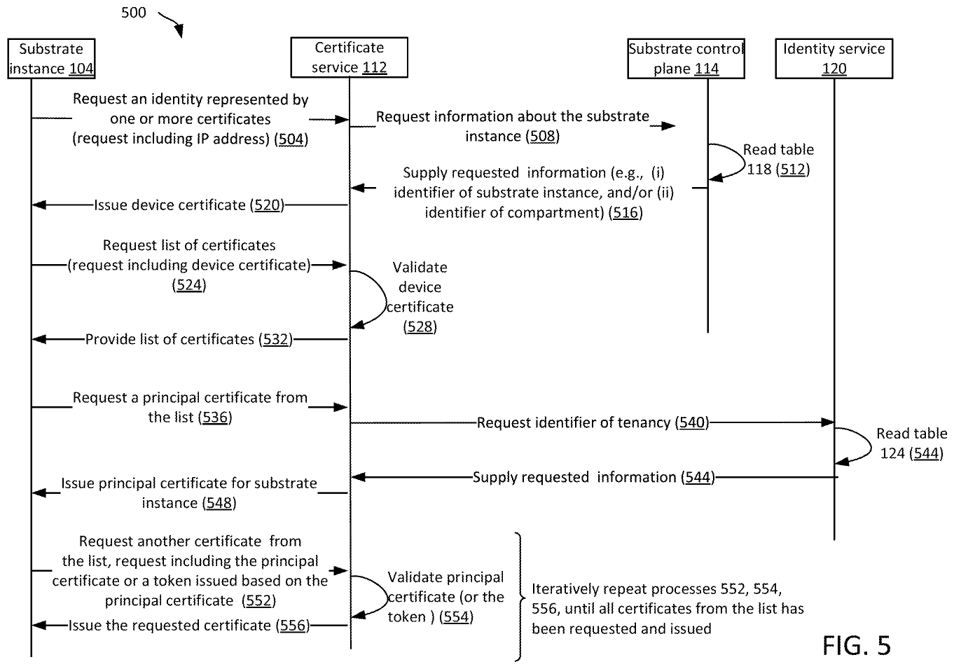

FIG. 5 illustrates a flow diagram 500 depicting communication between the substrate instance 104, the certificate service 112, the substrate control plane 114, and the identity service 120, e.g., for issuances of a plurality of certificates to the substrate instance 104. Although the flow diagram 500 of FIG. 5 is directed towards issuing certificates to specifically to the substrate instance 104, such a flow diagram can also be used to issue certificates to other substrate instances as well, such as the substrate instances illustrated in FIG. 2.

The flow diagram 500 includes, at 504, the substrate instance 104 requesting an identity represented by one or more certificates. The request at 504 is transmitted by the substrate instance 104 to the certificate service 112. In an example, the request at 504 includes or is accompanied by an IP address of the substrate instance 104. In an example, one of the agents 108a, . . . , 108n (such as the agent 108a) generates the request at 504.

Subsequently, at 508, the certificate service 112 requests information about the substrate instance from the substrate control plane 114. The request at 508 includes or is accompanied by the IP address of the substrate instance (which the certificate service 112 received at 504).

At 512, the substrate control plane 114 reads the table 118, and looks up information about the substrate instance from the table 118, e.g., using the IP address of the substrate instance (e.g., as described above with respect to FIG. 3). At 516, the substrate control plane 114 supplies the requested information about the substrate instance 104 to the certificate service 112. In an example, the information about the substrate instance 104 includes one or more of (i) an identifier of the substrate instance 104, and (ii) an identifier of a compartment including the substrate instance (such as the compartment 208a1). In an example, the information about the substrate instance 104 includes additional information, such as a host name of the substrate instance. Any other relevant information about the substrate instance 104 may also be included.

In an example, at 520, the certificate service 112 issues a device certificate to the substrate instance 104. The device certificate includes one or more fields, such as one or more of: a first field including an IP address of the substrate instance 104, a second field including the identifier of the substrate instance 104, a third field including the identifier of the compartment 208a1, a fourth field including a host name of the substrate instance 104, and/or any other relevant fields including one or more other relevant information associated with the substrate instance 104, such as information about the substrate instance 104 received from the substrate control plane 114.

Note that the device certificate lacks an identifier of a tenancy including the substrate instance 104, as the certificate service 112 may be so far unaware of the identifier of the tenancy (e.g., because the substrate control plane 114 may be unaware of the identifier of the tenancy).

In an example, the device certificate may also include a field indicating a time duration for which the device certificate is valid. In an example, the device certificate may also include a field indicating a permitted usage of the device certificate. For example, the device certificate may be used for issuance of one or more additional certificates, and the usage field of the device certificate may indicate that this certificate may be used (such as may only be used) for issuance of one or more additional certificates.

In an example, the device certificate is a digital certificate that specifies a public key of a key pair, and also includes an identifier of an entity to which the certificate is issued (e.g., includes one or more fields described above, which uniquely identifies the substrate instance 104). The device certificate thereby certifies that the identified entity is the owner of the public key of the key pair. A component wishing to validate the device certificate can do so using a corresponding private key of the key pair, in an example.

At 524, the substrate instance 104 (such as the agent 108a) requests a list of certificates that the substrate instance 104 (such as one or more of the agents 108a, . . . , 108n) can request from the certificate service 112. The request at 524 may include the device certificate that was issued to the substrate instance 104 at 520.

At 528, the certificate service 112 validates the device certificate. In an example, upon successful validation, to determine the requested list, the certificate service 112 checks one or more rules associated with the identifier of the compartment indicated by the device certificate. Based on such checking of the rules, the certificate service 112 identifies a plurality of certificates that the substrate instance 104 can request and generates the list based on the identified certificates. For example, the rules associated with the compartment 208a1 may specify that the substrate instances within this compartment may avail a first service, and not a second service. Accordingly, the certificate service 112 includes, within the list, a certificate needed to avail the first service, and doesn't include another certificate needed to avail the second service. In another example, the certificate service 112 may use one or more other techniques to select certification for inclusion in the list of certificates. At 532, the certificate service 112 transmits the determined list of certificates to the substrate instance 104.

In an example, the list of certificates identifies at least a principal certificate to be issued to the substrate instance 104, and one or more additional certificates to be issued to corresponding one or more agents of the substrate instance 104, e.g., to enable the one or more agents to avail corresponding one or more services. In an example, an agent (such as the agent 108a) receives the principal certificate. Other one or more agents (such as agents 108b, . . . , 108n) within the substrate instance relies on, and uses the principal certificate to receive the one or more additional certificates.

Subsequently, at 536, the substrate instance 104 requests a principal certificate from the list of certificates. In an example, the request for the principal certificate at 536 includes or is accompanied by the device certificate issued earlier to the substrate instance 104. In an example, the request for the principal certificate at 536 is generated and/or transmitted by an agent of the substrate instance 104, such as the agent 108a.

Once the certificate service 112 receives the request for the principal certificate, the certificate service 112 determines, from the accompanying device certificate, the identifier of the substrate instance 104 and/or the identifier of the compartment 208a1 including the substrate instance 104. At 540, the certificate service 112 requests an identifier of a tenancy that includes (i) the substrate instance 104 and/or (ii) the compartment 208a1 including the substrate instance 104. The request for the identifier of the tenancy at 540 may be accompanied by one or both of (i) the identifier of the substrate instance 104 derived from the device certificate, and/or (i) the identifier of the compartment 208a1 derived from the device certificate. The request for the identifier of the tenancy at 540 is transmitted to the identity service 120 that is different from the substrate control plane 114.

At 544, the identity service 120 reads the table 124, and looks up from the table 124 the identifier of the tenancy 202a including the substrate instance 104 and the compartment 208a1. The lookup of the identifier of the tenancy 202a can be performed based on the identifier of the substrate instance 104 and/or the identifier of the compartment 208a1, wherein the identifiers of the substrate instance 104 and/or the compartment 208a1 are received by the identity service 120 along with the request at 540. Looking up the identifier of the tenancy 202a, based on the identifier of the substrate instance 104 and/or the identifier of the compartment 208a1, has been described above with respect to FIGS. 4A-4C.

Subsequently, at 544, the identity service 120 supplies the looked-up identifier of the tenancy 202a to the certificate service 112. The certificate service 112 generates the principal certificate for the substrate instance 104, and issues the principal certificate to the substrate instance 104 at 548. In an example, the principal certificate is issued to one of the agents 108a, . . . , 108n within the substrate instance 104, such as issued to the agent 108a.

In an example, the principal certificate includes information associated with the substrate instance 104, the compartment 208a1 including the substrate instance 104, and/or the tenancy 202a including the compartment 208a1. Examples of information included within the principal certificate includes one or more of (i) the IP address of the substrate instance 104, (ii) the identifier of the substrate instance 104, (iii) the identifier of the compartment 208a1, (iv) the host name of the substrate instance 104, (v) the identifier of the tenancy 202a, (vi) a time duration for which the principal certificate is valid, (vii) one or more permitted usages of the principal certificate, (viii) a type of the instance to which the principal certificate is being issued (where the type may be a substrate instance, or may identify the type of the physical host of the substrate instance), and/or one or more other relevant information. Example of such one or more other relevant information may include information about the substrate instance 104, the compartment 208a1, and/or the tenancy 202a, which may be received by the certificate service 112 from the substrate control plane 114 and/or the identity service 120.

As described above, in an example, the principal certificate includes a field indicating a time duration for which the principal certificate is valid. For example, the principal certificate may be valid for a time duration that may range between 1 hour to 7 days, such as valid for a period of 24 hours. Before the expiration of the validity of the principal certificate, the substrate instance 104 may re-request issuance of the principal certificate, and accordingly, one or more processes of the flow diagram 500 may be repeated.

As described above, in an example, the principal certificate includes a field indicating one or more permitted usages of the principal certificate. In an example, this field of the principal certificate issued to the substrate instance 104 may restrict the usage of the principal certificate for code signing only. Thus, the principal certificate issued to the substrate instance 104 may be used by the substrate instance 104 to sign codes. The codes, when signed using the principal certificate, is considered to be authentic and valid.

In an example, the principal certificate issued to the substrate instance 104 may not be permitted to be used for mutual transport layer security (mTLS) authentication between the substrate instance 104 and another entity different from the substrate instance. For example, the principal certificate may not be recognized by an authentication authority for mTLS authentication between the substrate instance and another entity different from the substrate instance. Such restrictions on the usage of the principal certificate issued to the substrate instance 104 may be imposed by explicitly stating permitted usages of the principal certificate, where the permitted usage of the principal certificate issued to the substrate instance may not include such a usage.

In contrast, an overlay instance principal certificate issued to an overlay instance may be used for mTLS authentication between the overlay instance and another entity different from the overlay instance, wherein the overlay instance runs on the substrate instance 104.

In an example, the principal certificate issued to the substrate instance 104 is a digital certificate that specifies a public key corresponding to a key pair, and also includes an identifier of an entity to which the certificate is issued (e.g., includes one or more fields described above, which identifies the substrate instance 104). The principal certificate thereby certifies that the identified entity is the owner of the public key of the key pair. A component wishing to validate the principal certificate can do so using a corresponding private key of the key pair, in an example.

Referring again to FIG. 5, the flow diagram 500 continues from 548 to 552. Starting at 552, the substrate instance 104 (such as one or more of the agents 108a, . . . , 108n) iteratively requests a series of certificates from the list of certificates, and the certificate service 112 iteratively issues such certificates.

For example, at 552, the substrate instance 104 requests the certificate service 112 for another certificate from the list of certificates. In an example, the request at 552 is accompanied by the previously issued principal certificate. In another example, the issued principal certificate is exchanged for a token (e.g., which may be issued by the certificate service 112, or by an identity and access management service, or by another appropriate service), and this token may be used instead of (or in addition to) the principal certificate accompanying the request at 552. In any case, the principal certificate or the token accompanies one or more requests for additional certificates. The certificate service 112 validates the principal certificate (or the token) at 554, and issues the requested certificate to the substrate instance 104 at 556. Processes 552, 554, and 556 may be iteratively repeated, until each certificate within the list of certificates has been requested and issued to the substrate instance 104, in an example.

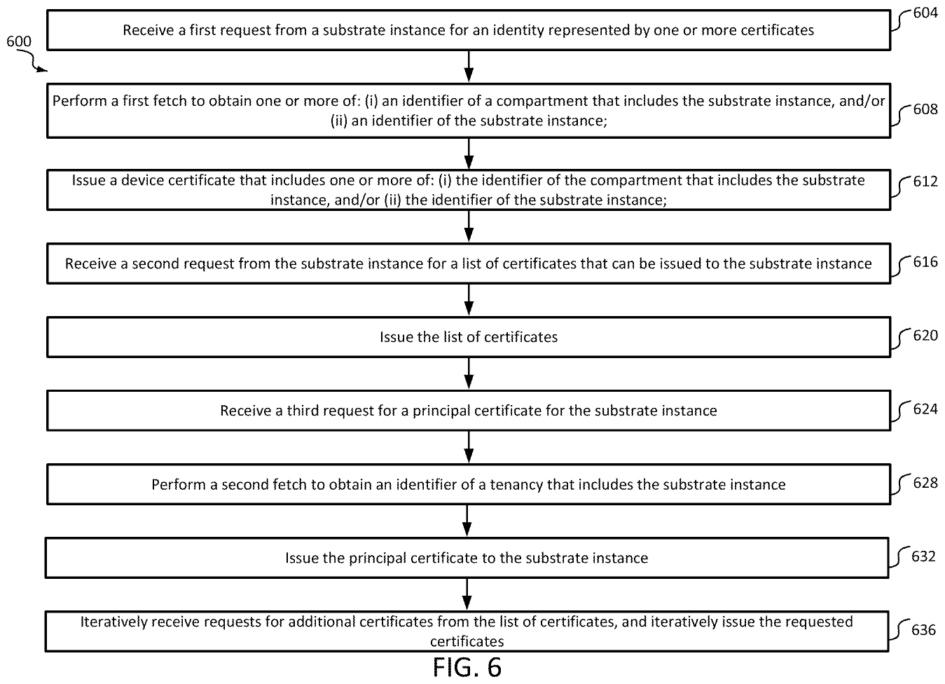

FIG. 6 is a flow diagram depicting a method 600 for issuances of a plurality of certificates to a substrate instance, such as the substrate instance 104.

The method 600 includes, at 604, receiving a first request from a substrate instance (such as the substrate instance 104) for an identity represented by one or more certificates. In an example, the first request may be a request for a device certificate. In an example, the first request may be referred to as a certificate request (e.g., because a certificate is being requested), or an identity request (e.g., because an identity represented by one or more certificates is being requested).

In an example, the request is received from the substrate instance 104 and at the certificate service 112. In an example, the first request includes an IP address of the substrate instance 104. In an example, one of the agents 108a, . . . , 108n (such as the agent 108a) generates and/or transmits the first request.

The method 600 proceeds from 604 to 608. At 608, a first fetch is performed, to obtain one or more of: (i) an identifier of a compartment that includes the substrate instance, and/or (ii) an identifier of the substrate instance. In an example, the first fetch is performed by the certificate service 112 and from the substrate control plane 114. For example, the substrate control plane 114 reads the table 118, and looks up information about the substrate instance from the table 118, e.g., using the IP address of the substrate instance. The substrate control plane 114 then transmits the requested information to the certificate service 112. As described above, the certificate service 112 fetches the information that includes one or more of (i) the identifier of the substrate instance 104, and/or (ii) the identifier of the compartment including the substrate instance (such as the compartment 208a1), and may include additional information, such as a host name of the substrate instance. Any other relevant information about the substrate instance may also be included.

The method 600 proceeds from 608 to 612. At 612, a device certificate is issued, where the device certificate includes one or more of: (i) the fetched identifier of the compartment that includes the substrate instance, and/or (ii) the fetched identifier of the substrate instance. In an example, the certificate service 112 issues the device certificate to the substrate instance 104. The device certificate includes one or more fields, such as a first field including an IP address of the substrate instance 104, a second field including the identifier of the substrate instance 104, a third field including the identifier of the compartment 208a1, a fourth field including the host name of the substrate instance, and/or any other relevant field including one or more other relevant information associated with the substrate instance 104 (or the associate compartment) received from the substrate control plane 114. In an example, the device certificate may also include a field indicating a time duration for which the device certificate is valid, as described above. In an example, the device certificate may also include a field indicating a permitted usage of the device certificate, as also described above. For example, the device certificate may be used for issuance of one or more additional certificates, and the usage field of the device certificate may indicate that this certificate may be used (such as may only be used) for issuance of one or more additional certificates. In an example, the device certificate is a digital certificate that specifies a public key corresponding to a key pair, and also includes an identifier of an entity to which the certificate is issued (e.g., includes one or more fields described above, which identifies the substrate instance 104). A component wishing to validate the device certificate can do so using a corresponding private key, in an example.

The method 600 proceeds from 612 to 616. At 616, a second request is received from the substrate instance for a list of certificates that can be issued to the substrate instance. For example, the substrate instance 104 (such as the agent 108a) requests the list of certificates from the certificate service 112. The request may include or be accompanied by the device certificate that was issued earlier to the substrate instance. The certificate service 112 validates the device certificate, and selects one or more certificates to be included in the list, e.g., as described above. In an example, the list includes a principal certificate for the substrate instance, and one or more additional certificates for one or more agents of the substrate instances, e.g., to enable the one or more agents to avail corresponding one or more services.

The method 600 proceeds from 616 to 620. At 620, the list of certificates is issued to the substrate instance, e.g., by the certificate service 112.

The method 600 proceeds from 620 to 624. At 624, a third request for a principal certificate for the substrate instance is received, e.g., by the certificate service 112 and from the substrate instance 104 (e.g., from one of the agents 108a, . . . , 108n, such as the agent 108a). In an example, the request for the principal certificate is accompanied by or includes the device certificate issued earlier to the substrate instance. In an example, the substrate instance 104 selects the principal certificate from the list of certificates, and transmits the third request for the principal certificate.

The method 600 proceeds from 624 to 628. At 628, a second fetch is performed to obtain an identifier of a tenancy that includes the substrate instance. For example, once the certificate service 112 receives the request for the principal certificate, the certificate service 112 determines, from the accompanying device certificate, the identifier of the substrate instance 104 and/or the identifier of the compartment 208a1 including the substrate instance 104. The certificate service 112 then requests an identifier of a tenancy including the substrate instance 104. The request for the identifier of the tenancy at 540 may be accompanied by one or both of (i) the identifier of the substrate instance 104 derived from the device certificate, and/or (i) the identifier of the compartment 208a1 derived from the device certificate. The request for the identifier of the tenancy is transmitted to the identity service 120 that is different from the substrate control plane 114. The identity service 120 reads the table 124, and looks up from the table 124 the identifier of the tenancy 202a including the substrate instance 104 and the compartment 208a1. The lookup of the identifier of the tenancy 202a can be performed based on the identifier of the substrate instance 104 and/or the identifier of the compartment 208a1, as also described above. Subsequently, the identity service 120 supplies the looked-up identifier of the tenancy 202a to the certificate service 112, thereby completing the second fetch.

The method 600 proceeds from 628 to 632. At 632, the principal certificate is issued to the substrate instance, e.g., by the certificate service 112. For example, the certificate service 112 generates the principal certificate for the substrate instance 104, and issues the principal certificate to the substrate instance 104. In an example, the principal certificate is issued to one of the agents 108a, . . . , 108n, such as issued to the agent 108a of the substrate instance. In an example, the principal certificate includes information associated with the substrate instance 104, the compartment 208a1 including the substrate instance 104, and/or the tenancy 202a including the compartment 208a1. Examples of information included within the principal certificate includes one or more of (i) the IP address of the substrate instance 104, (ii) the identifier of the substrate instance 104, (iii) the identifier of the compartment 208a1, (iv) the host name of the substrate instance 104, (v) the identifier of the tenancy 202a, (vi) a time duration for which the principal certificate is valid, (vii) one or more permitted usages of the principal certificate, (viii) a type of the instance to which the principal certificate is being issued (where the type may be a substrate instance, or may identify the type of the physical host of the substrate instance), and/or one or more other relevant information, as also described above. Example of such one or more other relevant information may include information about the substrate instance 104, the compartment 208a1, and/or the tenancy 202a, which may be received by the certificate service 112 from the substrate control plane 114 and/or the identity service 120.

The method 600 proceeds from 632 to 636. At 636, requests for additional certificates from the list of certificates are iteratively received, and the requested certificates are iteratively issued, e.g., as also described above with respect to 552, 554, and 556 of the flow diagram 500 of FIG. 5.

### Computer System Architecture

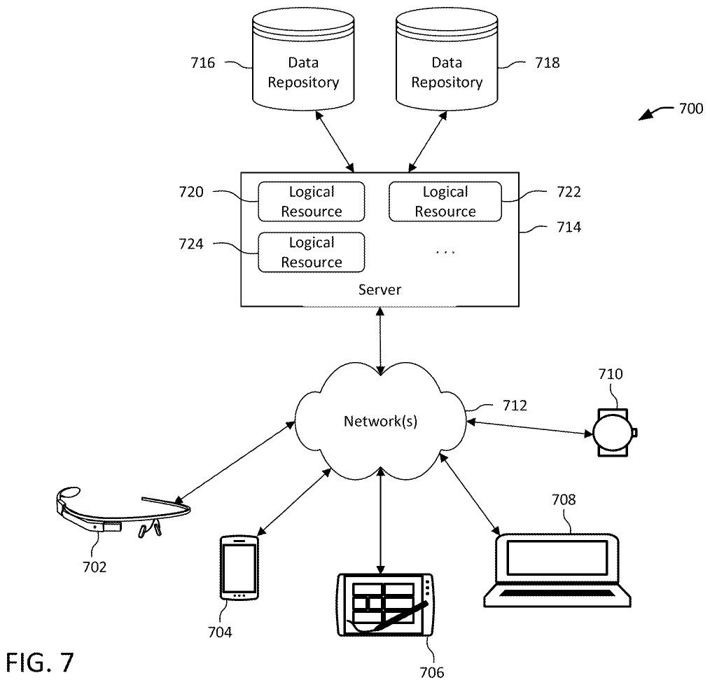

FIG. 7 depicts a simplified diagram of a distributed system 700 for implementing an embodiment. In the illustrated embodiment, distributed system 700 includes one or more client computing devices 702, 704, 706, 708, and/or 710 coupled to a server 714 via one or more communication networks 712. Clients computing devices 702, 704, 706, 708, and/or 710 may be configured to execute one or more applications.

In various aspects, server 714 may be adapted to run one or more services or software applications that enable techniques for issuing certificates to one or more substrate instances.

In certain aspects, server 714 may also provide other services or software applications that can include non-virtual and virtual environments. In some aspects, these services may be offered as web-based or cloud services, such as under a Software as a Service (SaaS) model to the users of client computing devices 702, 704, 706, 708, and/or 710. Users operating client computing devices 702, 704, 706, 708, and/or 710 may in turn utilize one or more client applications to interact with server 714 to utilize the services provided by these components.

In the configuration depicted in FIG. 7, server 714 may include one or more components 720, 722 and 724 that implement the functions performed by server 714. These components may include software components that may be executed by one or more processors, hardware components, or combinations thereof. It should be appreciated that various different system configurations are possible, which may be different from distributed system 700. The embodiment shown in FIG. 7 is thus one example of a distributed system for implementing an embodiment system and is not intended to be limiting.

Users may use client computing devices 702, 704, 706, 708, and/or 710 for techniques for issuing certificates to substrate instances, in accordance with the teachings of this disclosure. A client device may provide an interface that enables a user of the client device to interact with the client device. The client device may also output information to the user via this interface. Although FIG. 7 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 712 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 712 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 714 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 714 can include one or more virtual machines running virtual operating systems, or other computing architectures involving virtualization such as one or more flexible pools of logical storage devices that can be virtualized to maintain virtual storage devices for the server. In various aspects, server 714 may be adapted to run one or more services or software applications that provide the functionality described in the foregoing disclosure.

The computing systems in server 714 may run one or more operating systems including any of those discussed above, as well as any commercially available server operating system. Server 714 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 714 may include one or more applications to analyze and consolidate data feeds and/or event updates received from users of client computing devices 702, 704, 706, 708, and/or 710. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 714 may also include one or more applications to display the data feeds and/or real-time events via one or more display devices of client computing devices 702, 704, 706, 708, and/or 710.

Distributed system 700 may also include one or more data repositories 716, 718. These data repositories may be used to store data and other information in certain aspects. For example, one or more of the data repositories 716, 718 may be used to store information for techniques for issuing certificates to substrate instances. Data repositories 716, 718 may reside in a variety of locations. For example, a data repository used by server 714 may be local to server 714 or may be remote from server 714 and in communication with server 714 via a network-based or dedicated connection. Data repositories 716, 718 may be of different types. In certain aspects, a data repository used by server 714 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 716, 718 may also be used by applications to store application data. The data repositories used by applications may be of different types such as, for example, a key-value store repository, an object store repository, or a general storage repository supported by a file system.

In one embodiment, server 714 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

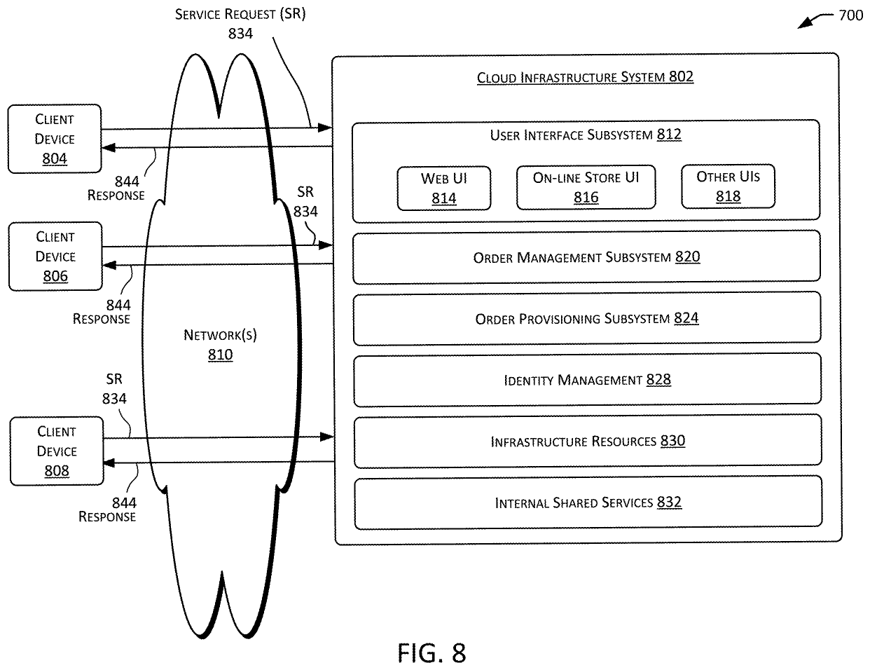

FIG. 8 is a simplified block diagram of a cloud-based system environment in which certificates are issued to substrate instances, in accordance with certain aspects. In the embodiment depicted in FIG. 8, cloud infrastructure system 802 may provide one or more cloud services that may be requested by users using one or more client computing devices 804, 806, and 808. Cloud infrastructure system 802 may comprise one or more computers and/or servers that may include those described above for server 712. The computers in cloud infrastructure system 802 may be organized as general purpose computers, specialized server computers, server farms, server clusters, or any other appropriate arrangement and/or combination.

Network(s) 810 may facilitate communication and exchange of data between clients 804, 806, and 808 and cloud infrastructure system 802. Network(s) 810 may include one or more networks. The networks may be of the same or different types. Network(s) 810 may support one or more communication protocols, including wired and/or wireless protocols, for facilitating the communications.

The embodiment depicted in FIG. 8 is only one example of a cloud infrastructure system and is not intended to be limiting. It should be appreciated that, in some other aspects, cloud infrastructure system 802 may have more or fewer components than those depicted in FIG. 8, may combine two or more components, or may have a different configuration or arrangement of components. For example, although FIG. 8 depicts three client computing devices, any number of client computing devices may be supported in alternative aspects.

The term cloud service is generally used to refer to a service that is made available to users on demand and via a communication network such as the Internet by systems (e.g., cloud infrastructure system 802) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 810 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 802 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 802 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 802. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 802. Cloud infrastructure system 802 then performs processing to provide the services requested in the tenant's subscription order. Cloud infrastructure system 802 may be configured to provide one or even multiple cloud services.

Cloud infrastructure system 802 may provide the cloud services via different deployment models. In a public cloud model, cloud infrastructure system 802 may be owned by a third party cloud services provider and the cloud services are offered to any general public tenant, where the tenant can be an individual or an enterprise. In certain other aspects, under a private cloud model, cloud infrastructure system 802 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 802 and the services provided may be shared by several organizations in a related community. Various other models such as hybrids of the above mentioned models may also be used.

Client computing devices 804, 806, and 808 may be of different types (such as devices 702, 704, 706, and 708 depicted in FIG. 7) and may be capable of operating one or more client applications. A user may use a client device to interact with cloud infrastructure system 802, such as to request a service provided by cloud infrastructure system 802.

In some aspects, the processing performed by cloud infrastructure system 802 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 802 for determining the intent of an utterance. The data used for this analysis may include structured data (e.g., data stored in a database or structured according to a structured model) and/or unstructured data (e.g., data blobs (binary large objects)).

As depicted in the embodiment in FIG. 8, cloud infrastructure system 802 may include infrastructure resources 830 that are utilized for facilitating the provision of various cloud services offered by cloud infrastructure system 802. Infrastructure resources 830 may include, for example, processing resources, storage or memory resources, networking resources, and the like.

In certain aspects, to facilitate efficient provisioning of these resources for supporting the various cloud services provided by cloud infrastructure system 802 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 802 may itself internally use services 832 that are shared by different components of cloud infrastructure system 802 and which facilitate the provisioning of services by cloud infrastructure system 802. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 802 may comprise multiple subsystems. These subsystems may be implemented in software, or hardware, or combinations thereof. As depicted in FIG. 8, the subsystems may include a user interface subsystem 812 that enables users of cloud infrastructure system 802 to interact with cloud infrastructure system 802. User interface subsystem 812 may include various different interfaces such as a web interface 814, an online store interface 816 where cloud services provided by cloud infrastructure system 802 are advertised and are purchasable by a consumer, and other interfaces 818. For example, a tenant may, using a client device, request (service request 834) one or more services provided by cloud infrastructure system 802 using one or more of interfaces 814, 816, and 818. For example, a tenant may access the online store, browse cloud services offered by cloud infrastructure system 802, and place a subscription order for one or more services offered by cloud infrastructure system 802 that the tenant wishes to subscribe to. The service request may include information identifying the tenant and one or more services that the tenant desires to subscribe to.

In certain aspects, such as the embodiment depicted in FIG. 8, cloud infrastructure system 802 may comprise an order management subsystem (OMS) 820 that is configured to process the new order. As part of this processing, OMS 820 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 820 may then invoke the order provisioning subsystem (OPS) 824 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 824 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 802 may send a response or notification 844 to the requesting tenant to indicate when the requested service is now ready for use. In some instances, information (e.g., a link) may be sent to the tenant that enables the tenant to start using and availing the benefits of the requested services.

Cloud infrastructure system 802 may provide services to multiple tenants. For each tenant, cloud infrastructure system 802 is responsible for managing information related to one or more subscription orders received from the tenant, maintaining tenant data related to the orders, and providing the requested services to the tenant or clients of the tenant. Cloud infrastructure system 802 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 802 may provide services to multiple tenants in parallel. Cloud infrastructure system 802 may store information for these tenants, including possibly proprietary information. In certain aspects, cloud infrastructure system 802 comprises an identity management subsystem (IMS) 828 that is configured to manage tenant's information and provide the separation of the managed information such that information related to one tenant is not accessible by another tenant. IMS 828 may be configured to provide various security-related services such as identity services, such as information access management, authentication and authorization services, services for managing tenant identities and roles and related capabilities, and the like.

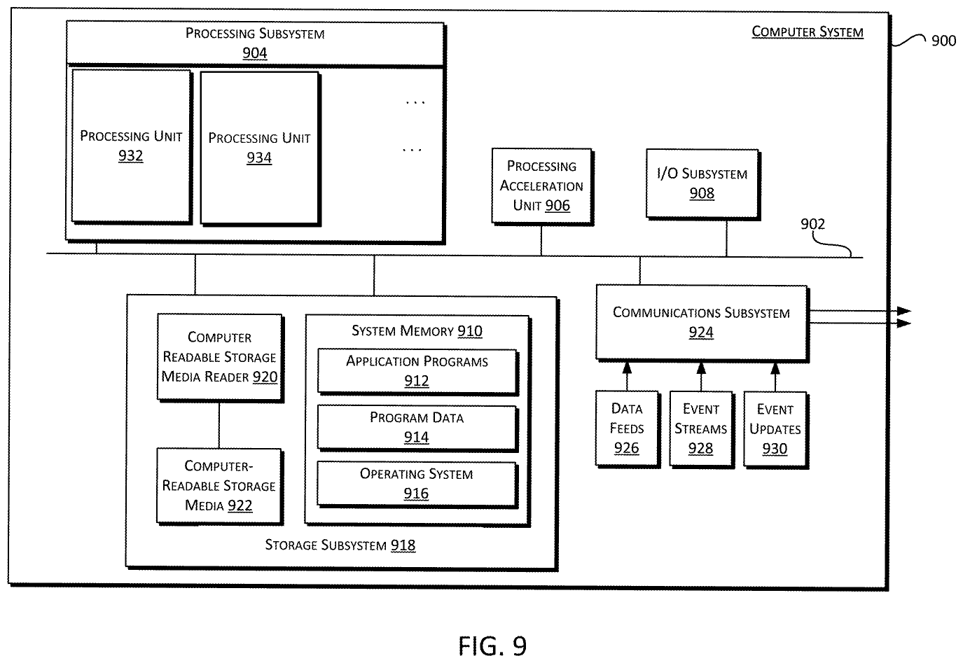

FIG. 9 illustrates an exemplary computer system 900 that may be used to implement certain aspects. As shown in FIG. 9, computer system 900 includes various subsystems including a processing subsystem 904 that communicates with a number of other subsystems via a bus subsystem 902. These other subsystems may include a processing acceleration unit 906, an I/O subsystem 908, a storage subsystem 918, and a communications subsystem 924. Storage subsystem 918 may include non-transitory computer-readable storage media including storage media 922 and a system memory 910.

Bus subsystem 902 provides a mechanism for letting the various components and subsystems of computer system 900 communicate with each other as intended. Although bus subsystem 902 is shown schematically as a single bus, alternative aspects of the bus subsystem may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 904 controls the operation of computer system 900 and may comprise one or more processors, application specific integrated circuits (ASICs), or field programmable gate arrays (FPGAs). The processors may include be single core or multicore processors. The processing resources of computer system 900 can be organized into one or more processing units 932, 934, etc. A processing unit may include one or more processors, one or more cores from the same or different processors, a combination of cores and processors, or other combinations of cores and processors. In some aspects, processing subsystem 904 can include one or more special purpose co-processors such as graphics processors, digital signal processors (DSPs), or the like. In some aspects, some or all of the processing units of processing subsystem 904 can be implemented using customized circuits, such as application specific integrated circuits (ASICs), or field programmable gate arrays (FPGAs).

In some aspects, the processing units in processing subsystem 904 can execute instructions stored in system memory 910 or on computer readable storage media 922. In various aspects, the processing units can execute a variety of programs or code instructions and can maintain multiple concurrently executing programs or processes. At any given time, some or all of the program code to be executed can be resident in system memory 910 and/or on computer-readable storage media 922 including potentially on one or more storage devices. Through suitable programming, processing subsystem 904 can provide various functionalities described above. In instances where computer system 900 is executing one or more virtual machines, one or more processing units may be allocated to each virtual machine.

In certain aspects, a processing acceleration unit 906 may optionally be provided for performing customized processing or for off-loading some of the processing performed by processing subsystem 904 so as to accelerate the overall processing performed by computer system 900.

I/O subsystem 908 may include devices and mechanisms for inputting information to computer system 900 and/or for outputting information from or via computer system 900. In general, use of the term input device is intended to include all possible types of devices and mechanisms for inputting information to computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 900 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some aspects. Storage subsystem 918 may store software (e.g., programs, code modules, instructions) that when executed by processing subsystem 904 provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes a system memory 910 and a computer-readable storage media 922. System memory 910 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 900, such as during start-up, may typically be stored in the ROM. The RAM typically contains data and/or program modules that are presently being operated and executed by processing subsystem 904. In some implementations, system memory 910 may include multiple different types of memory, such as static random access memory (SRAM), dynamic random access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and an operating system 916. By way of example, operating system 916 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 922 may store programming and data constructs that provide the functionality of some aspects. Computer-readable media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, digital video disc (DVD), a Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 918 may also include a computer-readable storage media reader 920 that can further be connected to computer-readable storage media 922. Reader 920 may receive and be configured to read data from a memory device such as a disk, a flash drive, etc.

In certain aspects, computer system 900 may support virtualization technologies, including but not limited to virtualization of processing and memory resources. For example, computer system 900 may provide support for executing one or more virtual machines. In certain aspects, computer system 900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices.

Communication subsystem 924 may support both wired and/or wireless communication protocols. For example, in certain aspects, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 924 can provide wired network connectivity (e.g., Ethernet) in addition to or instead of a wireless interface.

Communication subsystem 924 can receive and transmit data in various forms. For example, in some aspects, in addition to other forms, communications subsystem 924 may receive input communications in the form of structured and/or unstructured data feeds 926, event streams 928, event updates 930, and the like. For example, communications subsystem 924 may be configured to receive (or send) data feeds 926 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to communicate data from computer system 900 to other computer systems or networks. The data may be communicated in various different forms such as structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof.

Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A method for issuing one or more certificates to a substrate instance of a cloud environment, the method comprising:
performing a first fetch to obtain one or more of:
(i) an identifier of a compartment that includes the substrate instance, or
(ii) an identifier of the substrate instance;
performing a second fetch to obtain an identifier of a tenancy that includes the substrate instance, based at least in part on one or more of:
(i) the identifier of the compartment identified from the first fetch, or
(ii) the identifier of the substrate instance identified from the first fetch; and
issuing a principal certificate to the substrate instance, the principal certificate including the identifier of the tenancy that includes the substrate instance.

2. The method of claim 1, wherein the first fetch is performed by a certificate service from a substrate control plane for the cloud environment, and the second fetch is performed by the certificate service from an identity service for the cloud environment.

3. The method of claim 2, wherein the substrate control plane is configured to provision compute capacity in the substrate instance, and the identity service is configured to issue and/or maintain identities of a plurality of cloud resources within the cloud environment.

4. The method of claim 1, wherein the substrate instance uses the principal certificate for code signing.

5. The method of claim 1, wherein the principal certificate is not recognized by an authentication authority for mutual transport layer security (mTLS) authentication between the substrate instance and another entity different from the substrate instance.

6. The method of claim 5, wherein:
the principal certificate is a substrate instance principal certificate issued to the substrate instance;
an overlay instance principal certificate is issued to an overlay instance that runs on the substrate instance; and
the overlay instance principal certificate is recognized by the authentication authority for mTLS authentication between the overlay instance and another entity different from the overlay instance.

7. The method of claim 1, wherein the first fetch is performed, based at least in part on an Internet Protocol (IP) address associated with the substrate instance.

8. The method of claim 1, further comprising:
receiving a first request for issuance of a device certificate to the substrate instance, wherein the first fetch is performed responsive at least to receiving the first request; and
issuing the device certificate to the substrate instance, the device certificate including one or more of:
(i) the identifier of the compartment identified from the first fetch, or
(ii) the identifier of the substrate instance identified from the first fetch,
wherein the device certificate lacks the identifier of the tenancy that includes the substrate instance.

9. The method of claim 8, further comprising:
subsequent to issuing the device certificate, receiving a second request to identify one or more certificates to be issued to the substrate instance, the second request being associated with the device certificate;
identifying the one or more certificates to be issued to the substrate instance based at least in part on the device certificate, the one or more certificates to be issued to the substrate instance including the principal certificate; and
responsive at least to the second request, transmitting information identifying the one or more certificates to be issued to the substrate instance, wherein the information identifying the one or more certificates to be issued to the substrate instance is transmitted to the substrate instance.

10. The method of claim 9, further comprising:
subsequent to transmitting the information identifying the one or more certificates to be issued to the substrate instance, receiving a third request for the principal certificate,
wherein the second fetch is performed responsive at least to receiving the third request.

11. The method of claim 8, wherein the one or more certificates to be issued to the substrate instance includes, in addition to the principal certificate, an additional certificate, and wherein the method further comprises:
subsequent to issuing the principal certificate, receiving a third request for the additional certificate; and
issuing the additional certificate to the substrate instance, based at least in part on the principal certificate.

12. The method of claim 1, wherein the principal certificate has a field specifying a time duration for which the principal certificate is valid.

13. The method of claim 12, wherein the time duration for which the principal certificate is valid is within a range of 1 hour and 7 days.

14. The method of claim 1, wherein the principal certificate is issued to a public key infrastructure (PKI) agent operating within the substrate instance.

15. A method for issuing one or more certificates to a substrate instance of a cloud environment, the method comprising:
performing a first fetch to obtain one or more of:
(i) an identifier of a compartment that includes the substrate instance, or
(ii) an identifier of the substrate instance,
wherein the first fetch is performed by a certificate service from a substrate control plane;
performing a second fetch to obtain an identifier of a tenancy that includes the substrate instance, wherein the second fetch is performed by the certificate service from an identity service; and
issuing a principal certificate to the substrate instance, the principal certificate including the identifier of the tenancy that includes the substrate instance.

16. The method of claim 15, wherein the substrate control plane is configured to provision compute capacity in the substrate instance.

17. The method of claim 15, wherein the identity service is configured to issue and/or maintain identities of a plurality of cloud resources within the cloud environment.

18. The method of claim 15, further comprising:
subsequent to performing the first fetch and prior to performing the second fetch, issuing a device certificate to the substrate instance, the device certificate including one or more of:
(i) the identifier of the compartment identified from the first fetch, or
(ii) the identifier of the substrate instance identified from the first fetch,
wherein the device certificate lacks the identifier of the tenancy that includes the substrate instance.

19. A non-transitory computer-readable medium including instructions that when executed by one or more processors, cause the one or more processors to perform operations including:
performing a first fetch to obtain one or more of:
(i) an identifier of a compartment that includes a substrate instance of a cloud environment, or
(ii) an identifier of the substrate instance,
wherein the first fetch is performed by a certificate service from a substrate control plane;
performing a second fetch to obtain an identifier of a tenancy that includes the substrate instance, based at least in part on one or more of:
(i) the identifier of the compartment identified from the first fetch, or
(ii) the identifier of the substrate instance identified from the first fetch,
wherein the second fetch is performed by the certificate service from an identity service; and
issuing a principal certificate to the substrate instance, the principal certificate including the identifier of the tenancy that includes the substrate instance.

20. The non-transitory computer-readable medium of claim 19, wherein:
the substrate control plane is configured to provision compute capacity in the substrate instance; and
the identity service is configured to issue and/or maintain identities of a plurality of cloud resources within the cloud environment.
